(19) United States
(12) Patent Application Publication
(10) Pub. No.: US 2014/0380250 A1
(43) Pub. Date: Dec. 25, 2014

(54) IMAGE PROCESSING APPARATUS, IMAGE PROCESSING METHOD AND PROGRAM

(71) Applicant: CANON KABUSHIKI KAISHA, Tokyo (JP)

(72) Inventor: Hiroyoshi Yoshida, Tokyo (JP)

(73) Assignee: CANON KABUSHIKI KAISHA, Tokyo (JP)

(21) Appl. No.: 14/126,626

(22) PCT Filed: Sep. 20, 2013
(86) PCT No.: PCT/JP2013/076445

§ 371 Date: Dec. 16, 2013

(30) Foreign Application Priority Data
Sep. 27, 2012 (JP) 2012-215027

(51) Int. Cl. G06F 3/0488; G06F 3/0484

(52) U.S. Cl. CPC G06F 3/0488; G06F 3/04842
USPC 715/863

(57) ABSTRACT

An image processing apparatus comprises: an acquisition unit to acquire screen information related to whether or not an operation screen accepts an input by a gesture operation; a retrieval unit to retrieve, from screen information associated with a plurality of screen configuration patterns applicable to the operation screen, the screen information which coincides with the screen information acquired by the acquisition unit; a determining unit to determine the screen configuration pattern to be applied to the operation screen, based on the screen information retrieved by the retrieval unit; and an applying unit to apply a display rule of a screen element defined by the screen configuration pattern determined by the determining unit to a display screen of the operation screen, whereby a user can easily acknowledge whether or not to be able to perform the gesture operation on the screen on which the user intends to perform an operation.

This application is a National Stage application under 35 U.S.C. §371 of International Application No. PCT/JP2013/076445, filed on Sep. 20, 2013, which claims priority to Japanese Application No. 2012-215027, filed on Sep. 27, 2012, the contents of each of the foregoing applications being incorporated by reference herein.

### TECHNICAL FIELD

The present invention relates to an image processing apparatus, an image processing method, and a program to be used for the image processing method.

### BACKGROUND ART

Conventionally, in a case where a list screen which can include configuration items, thumbnail images, various lists and the like is displayed on an operation portion of an MFP (multifunction peripheral), if there are items which cannot be held within the one list screen, a user usually displays the items which cannot be displayed in the beginning by pressing or handling a page turning button, a scroll button or the like on the screen. Meanwhile, in recent years, there are mobile (or portable) devices of a kind of enabling a user to perform a slide operation (hereinafter, called a gesture operation) even on the list screen of displaying various lists or the like. Here, it should be noted that the gesture operation is an operation which can achieve operability suitable for user's intuitiveness by representing the list screen on an operation screen as if the list screen exists physically. More specifically, the gesture operation is an operation in which the user considers the list screen as a physical medium such as a paper, shifts the displayed content on the list screen by touching it with his/her finger, and releases the finger from the list screen when the displayed content has reached a desired position.

Incidentally, it is conceivable that the function or the like of exchanging data by using the mobile device is apparently used by a user who is accustomed to handling the mobile device. For this reason, if a general gesture operation can be achieved by the above-described mobile device, it leads to benefits for users.

However, since the MFP is a device which is mainly used as a business machine in an office or a business facility, it is necessary to target a user who does not own or have a recent mobile device and is not accustomed to performing the gesture operation. This is mainly because of the following reasons:

1) a person who decides to purchase the MFP does not coincide with a user who uses the purchased MFP; and
2) there are plurality of users who use the MFP, and these users respectively have various understandings in regard to the MFP.

For these reasons as described above, in the MFP, if the MFP is configured to accept the gesture operations on all of the list screens, disadvantages are caused for the users who are not accustomed to the mobile device.

Consequently, in the MFP, it is necessary for the user to make a choice as to whether to perform the gesture operation on the screen provided for users who are accustomed to the mobile device or not to perform the gesture operation on the screen for users who are not accustomed to the mobile device. This implies that the one MFP has different two operation functions. For this reason, it is very inconvenient for the user who uses both the two operation functions because it is varied which operation function can be used on which screen, and accordingly problems are likely to occur.

Here, PTL1 discloses a technique of guiding, to a user who cannot understand how to handle or operate a device, usable operations by explicating them according to operational stages.

### CITATION LIST

### Patent Literature

PTL 1: Japanese Patent Application Laid-Open No. H05-012286

### SUMMARY OF INVENTION

### Technical Problems

The problems which are likely to occur in the above related art will be described as follows.

For example, it is assumed that a user believes that he/she can perform the gesture operation on a given screen. In this case, if it is impossible in fact to perform the gesture operation on this screen, since the user cannot of course perform the gesture operation thereon, the problem that the user resultingly gives up performing the gesture operation occurs.

On the other hand, it is assumed that a user believes that he/she cannot perform the gesture operation on a given screen. In this case, even if it is possible in fact to perform the gesture operation on this screen, since the user does not naturally perform the gesture operation thereon, the problem that the user gives up performing the gesture operation from the beginning occurs.

Consequently, in consideration of the above problems, the present invention aims to provide a technique of enabling a user to easily acknowledge whether or not to be able to perform the gesture operation on a screen on which the user intends to perform an operation.

### Solution to Problem

In order to achieve such an object as described above, the present invention provides: an acquisition unit configured to acquire screen information related to whether or not an operation screen accepts an input by a gesture operation; a retrieval unit configured to retrieve, from screen information associated with a plurality of screen configuration patterns applicable to the operation screen, the screen information which coincides with the screen information acquired by the acquisition unit; a determining unit configured to determine the screen configuration pattern to be applied to the operation screen, based on the screen information retrieved by the retrieval unit; and an applying unit configured to apply a display rule of a screen element defined by the screen configuration pattern determined by the determining unit to a display screen of the operation screen.

### Advantageous Effects of Invention

According to the present invention, it is possible for a user to easily acknowledge whether or not a screen on which the user intends to perform an operation is a screen on which he/she can perform a gesture operation.

Further features of the present invention will become apparent from the following description of exemplary embodiments with reference to the attached drawings.

### BRIEF DESCRIPTION OF DRAWINGS

FIG. 1 is a block diagram illustrating an example of a hardware constitution of an image forming apparatus.

FIG. 2 is a diagram illustrating an example of an outer appearance of an operation unit of the image forming apparatus.

FIG. 3A is a diagram illustrating an example of a preview screen according to a first embodiment.

FIG. 3B is a diagram illustrating an example of a preview screen according to the first embodiment.

FIG. 4 is a diagram illustrating an example of a software configuration to be used in the image forming apparatus.

FIG. 5 is a diagram illustrating an example of a speed curve in a slide operation by a flick operation according to the first embodiment.

FIG. 6 is a flow chart indicating an example of a process to be performed by a slide operation module according to the first embodiment.

FIG. 7 is a diagram illustrating an example of document management data according to the first embodiment.

FIG. 8 is a diagram illustrating an example of the slide operation by the flick operation according to the first embodiment.

FIG. 9 is a diagram illustrating an example of job list data according to the first embodiment.

FIG. 10 is a diagram illustrating an example of a screen configuration pattern according to the first embodiment.

FIG. 11 is a flow chart indicating an example of a process related to a display of an operation screen according to the first embodiment.

FIG. 12A is a diagram illustrating an example of a job list screen according to the first embodiment.

FIG. 12B is a diagram illustrating an example of the job list screen according to the first embodiment.

FIG. 13A is a diagram illustrating an example of the job list screen according to the first embodiment.

FIG. 13B is a diagram illustrating an example of the job list screen according to the first embodiment.

FIG. 14A is a diagram illustrating an example of the preview screen according to the first embodiment.

FIG. 14B is a diagram illustrating an example of the preview screen according to the first embodiment.

FIG. 15 is a diagram illustrating an example of a screen configuration pattern according to a second embodiment.

FIG. 16A is a diagram illustrating an example of a job list screen according to the second embodiment.

FIG. 16B is a diagram illustrating an example of the job list screen according to the second embodiment.

FIG. 16C is a diagram illustrating an example of the job list screen according to the second embodiment.

FIG. 17A is a diagram illustrating an example of a preview screen according to the second embodiment.

FIG. 17B is a diagram illustrating an example of the preview screen according to the second embodiment.

FIG. 18 is a diagram illustrating an example of a screen on which a warning pop-up according to a third embodiment is displayed.

### DESCRIPTION OF EMBODIMENTS

Hereinafter, embodiments of the present invention will be described with reference to the attached drawings. Incidentally, it should be noted that an MFP will be exemplarily described as an image forming apparatus in the following embodiments.

### First Embodiment

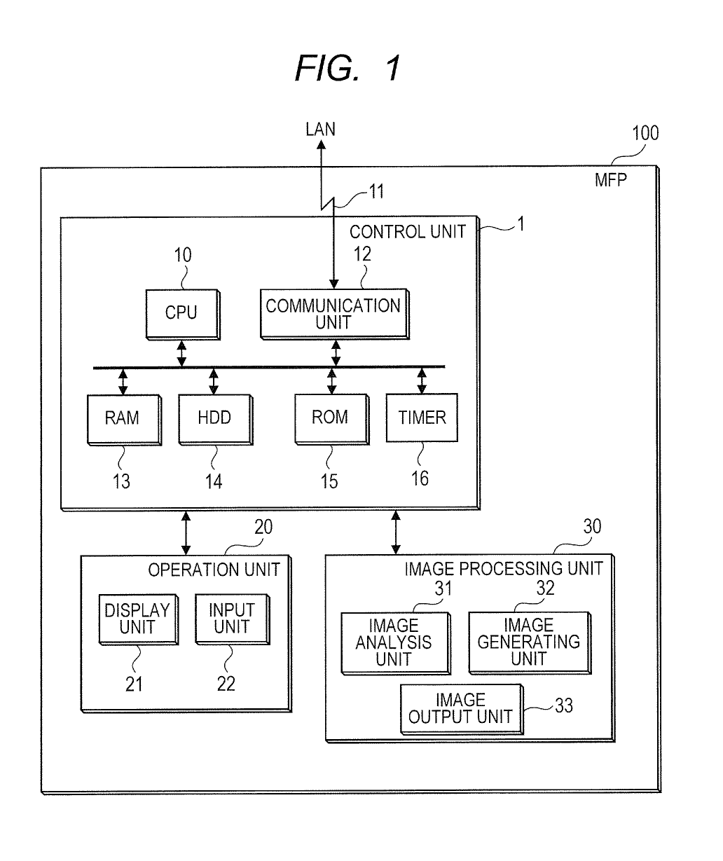

FIG. 1 is a block diagram illustrating an example of a hardware constitution of an MFP 100. Incidentally, as described above, the MFP 100 is an example of an image forming apparatus.

A control unit 1 controls an operation of each of units provided in the MFP 100. Moreover, the control unit 1 includes a CPU (central processing unit) 10, a LAN (local area network) 11, a communication unit 12, a RAM (random access memory) 13, an HDD (hard disk drive) 14, a ROM (read only memory) 15 and a timer 16.

The CPU 10 achieves functions (software functions) of later-described respective units of the MFP 100 and processes indicated by later-described flow charts, by performing various processes on the basis of programs stored in the HDD 14.

The LAN 11 is a network through which data is transmitted and received between the MFP 100 and an external device or the like. Namely, the MFP 100 is connected to the Internet or the like through the LAN 11.

The communication unit 12 transmits/receives various data to/from the external device or the like through the LAN 11.

The RAM 13 mainly functions as a system working memory which is used by the CPU 10 to perform various operations. The HDD 14 stores therein document data, configuration data and the like. Incidentally, another storage medium such as a magnetic disk, an optical medium, a flash memory or the like may be used as the HDD 14. Here, it should be noted that the HDD 14 is not an indispensable constituent element in the MFP 100. That is, it is possible, instead of the MFP 100, to use, as a storage device, an external device such as an external server, a PC (personal computer) or the like through the communication unit 12.

The ROM 15, which is a boot ROM, stores therein a system boot program and the like.

The timer 16 acquires data related to a passage of time in response to an instruction issued by the CPU 10, and then transfers, by an interrupt process or the like, a certain notification to the CPU 10 when a time instructed by the CPU 10 passes.

An operation unit 20, which includes a display unit 21 and an input unit 22, is controlled by the control unit 1.

Here, the display unit 21 is a display or the like which displays information related to the MFP 100 for a user.

Moreover, the input unit 22 accepts various inputs from the user through an interface such as a touch panel, a mouse, a camera, a voice input device, a keyboard or the like.

An image processing unit 30, which includes an image analysis unit 31, an image generating unit 32 and an image output unit 33, is controlled by the control unit 1.

Here, the image analysis unit 31 analyses a structure of an original image, and then extracts necessary information from an analyzed result of the original image.

Moreover, the image generating unit 32 reads an original by, for example, scanning or the like, digitizes an image of the read original, and stores image data generated as a result of the digitizing in the HDD 14. Incidentally, the image generating unit 32 can also generate the image data in a different format by using the information analyzed and extracted by the image analysis unit 31.

The image output unit 33 outputs the image data stored in the HDD 14 or the like. More specifically, the image output unit 33 can print the image data on a paper, transmit the image data to an external device, a server, a facsimile device or the like which is connected on a network through the communication unit 12, and store the image data in a storage medium which is connected to the MFP 100.

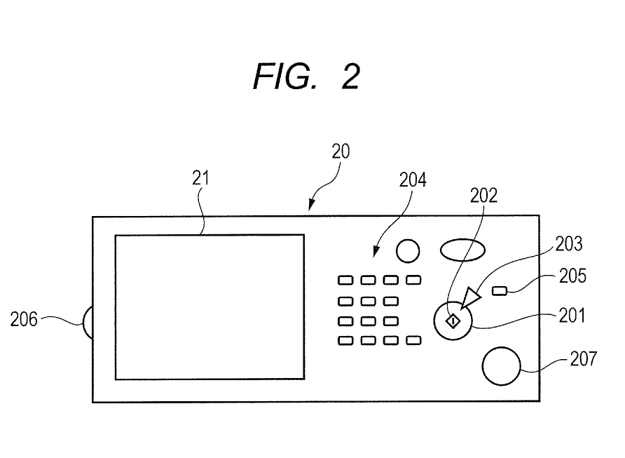

FIG. 2 is a diagram illustrating an example of an outer appearance of the operation unit 20 of the image forming apparatus.

More specifically, the display unit 21 is a liquid crystal display unit which has a liquid crystal screen covered with a touch panel sheet. The display unit 21 displays an operation screen and softkeys, and, when the displayed key is pressed by a user, notifies the CPU 10 of position information corresponding to the position of the pressed key. Consequently, the display unit 21 in this case serves as the input unit 22.

Hereinafter, various keys and buttons to be handled or operated by the user will be described.

A start key 201 is operated when, for example, the user instructs the MFP 100 to start a reading operation of an original image. Moreover, the start key 201 includes a two-color (green and red) LED (light emitting diode) 202 at its central part so as to indicate by these colors whether or not the start key 201 is in a usable state.

A stop key 203 is operated when the user instructs the MFP 100 to stop a running operation.

A numeric keypad 204, which includes numeric buttons and character buttons, is used when the user sets the number of copies to the MFP 100, switches a screen displayed on the display unit 21, and the like.

A user mode key 205 is operated when the user performs a configuration in regard to the MFP.

Both a dial 206 and a trackball 207 are used when the user performs an input operation for control in a later-described slide operation.

Hereinafter, a preview function in the present embodiment will be described.

In the present embodiment, it should be noted that the preview function (hereinafter, simply called preview) is a function of the CPU 10 to display the image data stored in the HDD 14 on the display unit 21. Here, as described above, the image analysis unit 31 analyses the structure of the original image, and extracts the necessary information from the analyzed result, thereby achieving informatization of the original image. The image generating unit 32 generates the image data in the format suitable for a display on the display unit 21 by using the information analyzed and extracted by the image analysis unit 31. Hereinafter, the image data which is generated by the image generating unit 32 and is suitable for the display on the display unit 21 will be called a preview image. Here, it is assumed that the original image includes one or more pages, and that the preview image is generated for each page.

The MFP 100 can store the image data of the original image in the HDD 14 by one or more methods. Moreover, the MFP 100 can generate the image data of the original image by reading an original document including the original image put on a scanner, i.e., a platen or an ADF (automatic document feeder), through the image generating unit 32 and then digitizing the read original image. Besides, the MFP 100 can duplicate and move the image data between the MFP and an arbitrary server on a network through the communication unit 12. Moreover, a storage medium such as a portable medium or the like can be implemented to the MFP 100, and the image data can be duplicated and moved from the storage medium to the HDD 14.

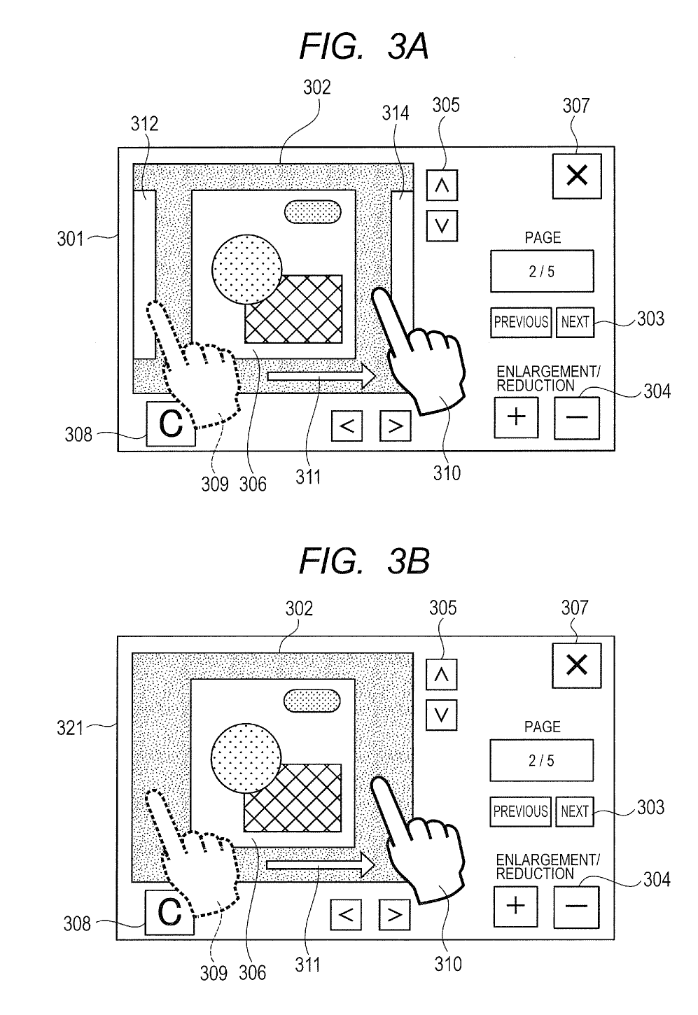

FIG. 3A is a diagram illustrating an example of a preview screen 301 to be displayed on the display unit 21 of the MFP 100 according to the present embodiment.

Here, it should be noted that the preview screen 301 in the present embodiment is a screen which is used to display a preview image 306. More specifically, the preview screen 301 includes a preview display area 302, page scroll buttons 303, enlargement/reduction buttons 304, display area movement buttons 305, a close button 307 and a list display update button 308.

It is also possible in the preview display area 302 to display preview images of a plurality of pages at a time. In the example illustrated in FIG. 3A, only one page of the preview image 306 is basically displayed in the preview display area 302. However, in order to indicate that the previous and next pages of the preview images exist, parts (312, 314) of the previous and next pages of the preview images are displayed at both ends of the relevant one page of the previous image in the preview display area 302.

The page scroll buttons 303 are control buttons which are used, when the previous and next pages of the preview images exist, to change the preview image to be displayed in the preview display area 302 to the page in the direction indicated by the user.

The enlargement/reduction buttons 304 are control buttons which are used to change a display magnification of the preview image to be displayed in the preview display area 302. More specifically, the user can instruct to arbitrarily change the magnification of the preview image 306 by appropriately pressing the enlargement/reduction buttons 304. Incidentally, it is assumed that the display magnification is sectioned by one or more grades.

The display area movement buttons 305 are control buttons which are used to change the display position of the preview image 306 in the preview display area 302. More specifically, when the user enlarges the display magnification of the preview image 306 by pressing the enlargement/reduction buttons 304, there is a possibility that only a part of the preview image 306 is displayed in the preview display area 302. In the case where the whole of the preview image 306 is not displayed in the preview display area 302, the user can display an arbitrary position of the preview image 306 in the preview display area 302 by appropriately pressing the display area movement buttons 305.

The close button 307 is a control button which is used to close the preview screen 301 and switch it to another screen, thereby terminating the preview function.

The list display update button 308 is a button which is used to again acquire the display information, thereby updating the display of the preview display area 302 to a latest state.

Incidentally, FIG. 3A shows the example of the preview screen 301 as described above, and further indicates an example of a state that the user controls, on the preview screen, a change of each page in the list display by a gesture operation. Here, it should be noted that the list display is a list screen of the preview images to be displayed in the preview display area 302 by the gesture operation. In any case, the list display includes not only the list display by the preview images illustrated in FIG. 3A but also, e.g., a later-described list display by lists illustrated in FIG. 8.

When the user moves an input pointer by touching the screen, the input unit 22 stores the track of the input pointer to accept the gesture operation by the user. More specifically, the input unit 22 can acquire the coordinates of the input pointer displayed on the display unit 21. Moreover, the input unit 22 can acquire the discrete coordinates of the input pointer by acquiring at certain intervals the coordinates of the input pointer displayed on the display unit 21. Moreover, the input unit 22 stores the acquired coordinates of the input pointer in the RAM 13. Incidentally, the input unit 22 can acquire the track of the input pointer by vectorizing the coordinates within a certain period of time stored in the RAM 13. Further, the input unit 22 judges whether or not a predetermined gesture operation and the track of the input pointer coincide with each other, and, when it is judged that the predetermined gesture operation and the track of the input pointer coincide with each other, the input unit can accept the track of the input pointer as the gesture operation.

It should be noted that, in general, the gesture operation includes a tap, a double tap, a drag, a flick and a pinch. More specifically, the tap is an operation of lightly beating the screen by a finger, and is corresponding to an operation of clicking a mouse. The double tap is an operation of successively performing a tap twice, and is corresponding to an operation of double-clicking a mouse. The drag is an operation of shifting a finger while performing a tap. The flick, which is similar to a drag, is an operation of releasing a finger while maintaining shifting speed. The pinch is a general operation of holding a target between two fingers. Moreover, in the pinch, an operation of widening the distance between the two fingers is called a pinch out, and an operation of narrowing the distance between the two fingers is called a pinch in.

Moreover, FIG. 3A indicates an example of a state that the user controls a change of the page by a flick operation instead of pressing of the page scroll buttons 303. Incidentally, it is assumed that the predetermined gesture operation in the example of FIG. 3A is a gesture operation in left and right directions. Moreover, in the example of FIG. 3A, the user performs a tap at a position 309, performs a drag to the right as indicated by an arrow 311, and then releases the finger at a position 310 while maintaining the drag speed, thereby performing the flick operation to the right. By the flick operation to the right by the user, the CPU 10 can slide and display the preview image 312 corresponding to the previous page. Incidentally, when the user performs the flick operation to the opposite direction, i.e., to the left, then the CPU 10 can slide and display the preview image 314 corresponding to the next page.

FIG. 3B is a diagram illustrating an example of a preview screen 321 to be displayed on the display unit 21 of the MFP 100 according to the present embodiment. Here, it should be noted that this preview screen is different from that of FIG. 3A in the point that the parts (312, 314) of the preview images are not displayed at both ends in the preview display area 302. That is, the CPU 10 can select whether or not to display the parts of the preview images at both ends in the preview display area 302.

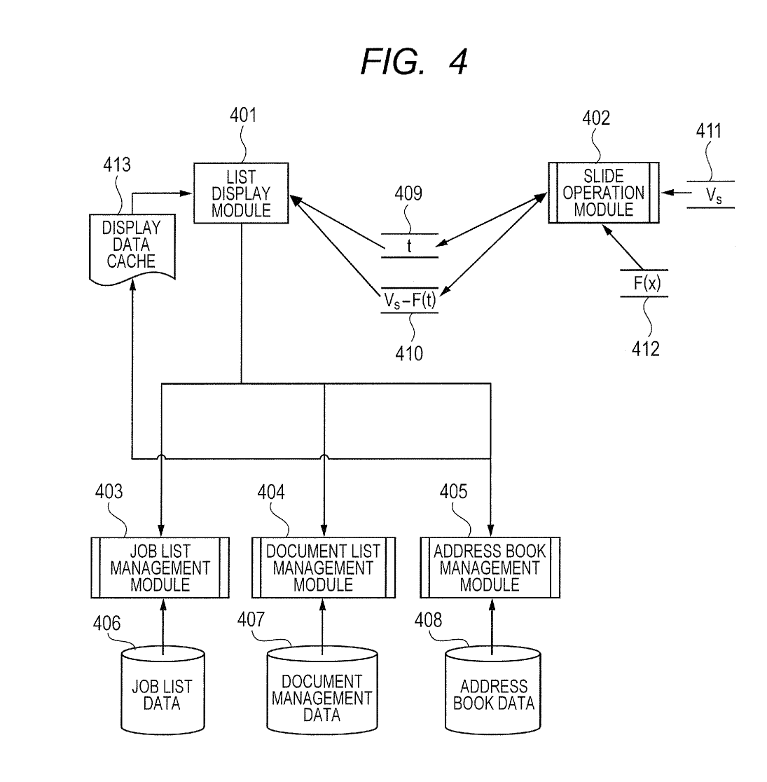

FIG. 4 is a diagram illustrating an example of a software configuration to be used in the MFP 100.

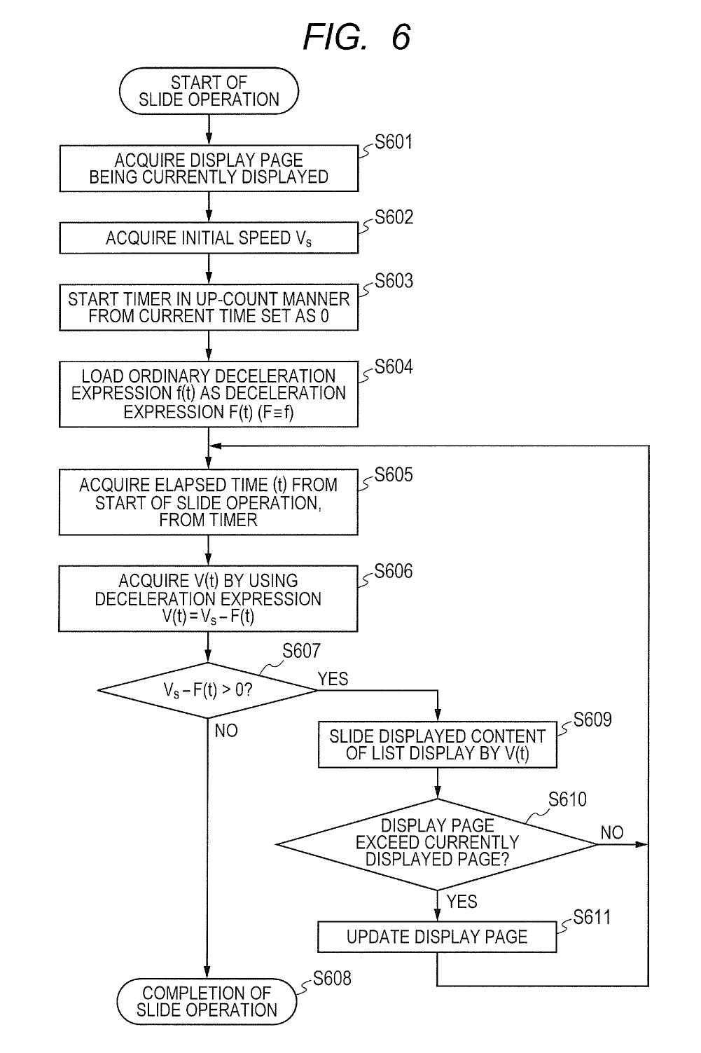

In the drawing, a list display module 401 is a module which is started when the CPU 10 displays the list display in the preview display area 302. In any case, the detail of the operation of the list display module 401 will be described later. A slide operation module 402 is a module which is started when the CPU 10 judges, by the flick operation or the like of the user, that the list display related to the preview image is slid and displayed. In any case, an operation flow of the slide operation module 402 will be described later with reference to a flow chart illustrated in FIG. 6.

A job list management module 403, a document list management module 404 and an address book management module 405, which are resident modules, are started after the MFP 100 was started. The job list management module 403, the document list management module 404 and the address book management module 405 can refer to job list data 406, document management data 407 and address book data 408, respectively.

Subsequently, coordinated operations of the respective modules will be described hereinafter.

Namely, the list display module 401 issues a DataReq (data request) to acquire display data from each of the job list management module 403, the document list management module 404 and the address book management module 405.

Then, when the DataReq is received from the list display module 401, each of the job list management module 403, the document list management module 404 and the address book management module 405 reads data from a list item data managed by each module. Moreover, each of the job list management module 403, the document list management module 404 and the address book management module 405 notifies the list display module 401 of the data read from the list item data managed by each module.

Incidentally, it should be noted that the list item data managed by the job list management module 403 is the job list data 406, the list item data managed by the document list management module 404 is the document management data 407, and the list item data managed by the address book management module 405 is the address book data 408.

Then, the list display module 401 causes a display data cache 413 to store the data respectively received from the job list management module 403, the document list management module 404 and the address book management module 405.

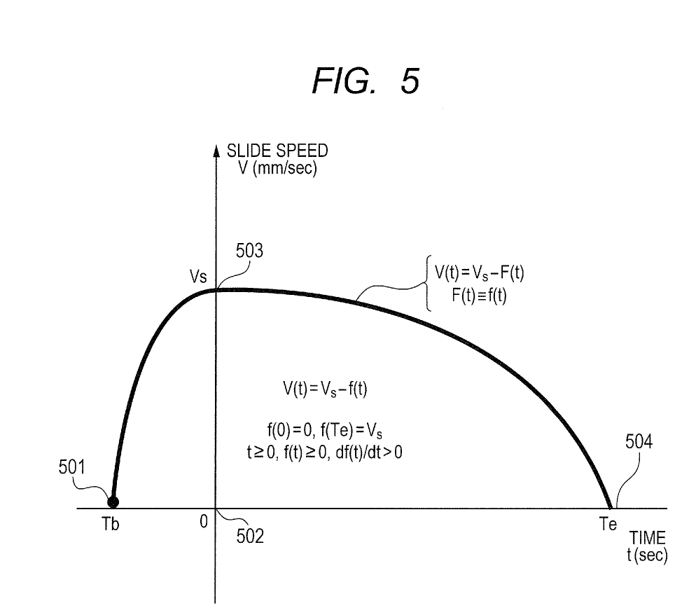

Further, the list display module 401 refers to a slide duration time t (409) and a slide speed V=(Vₛ−F(t)) (410) which are updated by the slide operation module 402, in order to control the slide operation by the gesture operation of the user. Here, it should be noted that the slide duration time t (409) is equivalent to an elapsed time from a start of the slide operation as indicated by FIG. 5.

Then, the slide operation module 402 updates the slide duration time t (409) and the slide speed V=(Vₛ−F(t)) (410), by referring to an initial speed Vₛ (411) and an ordinary deceleration expression f(x) (412). Incidentally, the details of the slide speed (Vₛ−F(t)) (410), the initial speed Vₛ (411) and the deceleration expression F(x) (412) will be described later.

Subsequently, the slide operation by the flick operation of the user will be described with reference to FIGS. 5 and 6.

Incidentally, it should be noted that the flick operation is an example of the gesture operation.

FIG. 5 is the diagram illustrating an example of a speed curve in which the slide operation by the flick operation of the user is represented using the ordinary deceleration expression f(x) (412). Here, it should be noted that the ordinary deceleration expression f(x) is equivalent to a function which satisfies f(0)=0, f(Tₑ)=Vₛ, t≧0, f(t)≧0, and df(t)/df>0, and represents virtual friction for stopping the slide operation.

A tap start time by the user is t=T_{b} (501). Subsequently, the user increases the slide speed V up to an initial speed Vₛ (503) by the drag operation, and then releases the finger from the screen at a time t=0 (502) (flick operation).

Here, the slide speed V indicates only the components in the left and right directions of the speed of the drag operation (including the flick operation) by the user. Moreover, the initial speed Vₛ (503) is equivalent to the slide speed V at the point that the user releases the finger from the screen at the time t=0 (502). Moreover, since the slide speed V from the time t=t_{b} (501) to the time t=0 (502) follows the speed of the drag operation by the user, the slide speed does not necessarily correspond to the simple rising curve as indicated in FIG. 5.

Then, when it is detected that the flick operation is performed by the user, the CPU 10 starts the slide operation module 402.

FIG. 6 is the flow chart indicating an example of the process to be performed by the slide operation module 402.

Incidentally, the process described below is started when the CPU 10 detects the start of the slide operation by the flick operation of the user.

In S601, the CPU 10 acquires page information representing the currently displayed page from the RAM 13 or the like, and advances the process to S602.

In S602, the CPU 10 acquires, from the RAM 13 or the like, the initial speed Vₛ (503) which is the speed at the point that the user releases the finger from the screen at the time t=0 (502), and advances the process to S603.

In S603, the CPU 10 sets the current time of the timer 16 as t=0, starts a timing operation of the timer 16 in an up-count manner, and then advances the process to S604.

In S604, the CPU 10 loads the ordinary deceleration expression f(x) (412) as the deceleration expression F(t) (F=f), and advances the process to S605. Here, it should be noted that the ordinary deceleration expression f(x) (412) is an example of the deceleration expression F(t).

In S605, the CPU 10 acquires, from the timer 16, the elapsed time (t) from the start of the slide operation, and advances the process to S606.

In S606, the CPU 10 calculates and acquires the slide speed V(t)=(Vₛ−F(t)) (410) by using the ordinary deceleration expression f(t) as the deceleration expression F(t), and advances the process to S607.

In S607, the CPU 10 judges whether or not the slide speed (Vₛ−F(t)) (410) is larger than 0, and, when it is judged that Vₛ−F(t)=0, advances the process to S608. Incidentally, it should be noted that the state of Vₛ−F(t)=0 is equivalent to the state of t=Tₑ (504) indicated in FIG. 5. In S608, the CPU 10 completes the slide operation.

On the other hand, when it is judged in S607 that Vₛ−F(t)>0, the CPU 10 advances the process to S609.

In S609, the CPU 10 slides the display items of the list display by an amount corresponding to the slide speed V(t), and advances the process to S610.

In S610, the CPU 10 judges whether or not, as a result of the slide operation in S609, the display page exceeds the currently displayed page, and, when it is judged that the display page exceeds the currently displayed page, advances the process to S611. On the other hand, when it is judged that the display page does not exceed the currently displayed page yet, the CPU returns the process to S605.

In S611, the CPU 10 updates the display page, and then returns the process to S605. Incidentally, an operation related to the update of the display page will be described later.

By the above processes, in the slide operation by the flick operation of the user, the CPU 10 can slide and display the display items of the list display while decreasing the slide speed by the virtual friction.

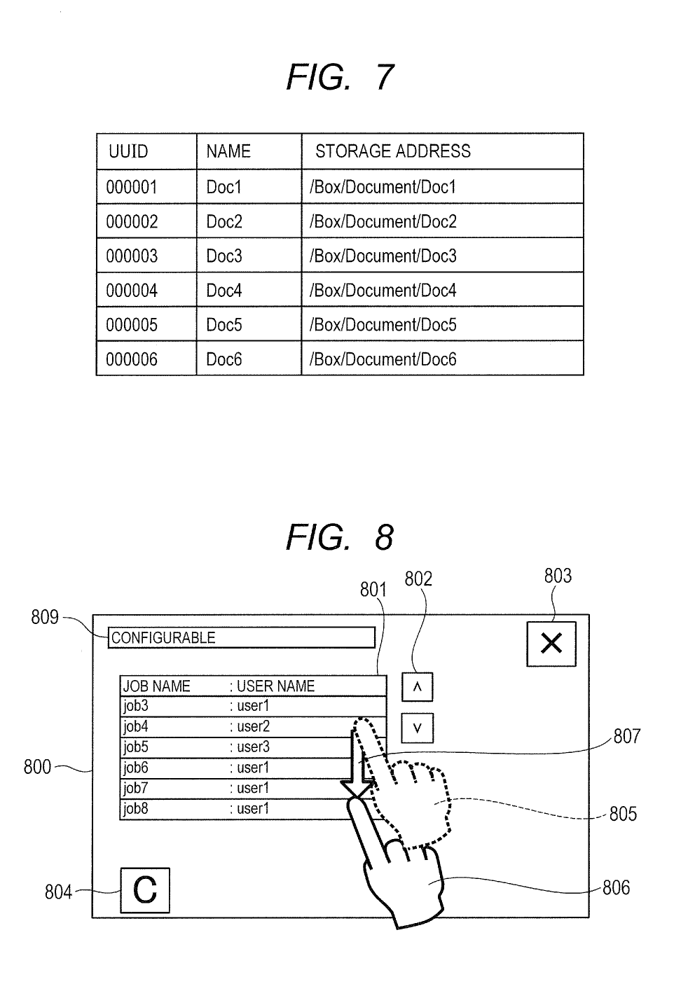

FIG. 7 is a diagram illustrating an example of the document management data 407.

More specifically, the display page in the document management data 407 will be described.

In the state illustrated in FIG. 3A, if it is assumed that the information of the document corresponding to the preview image 306 is “000003” of UUID in the document management data 407 illustrated in FIG. 7, this represents that the display page is “000003”.

In this case, if it is judged in S610 that the display page is the preview image 312 of the page previous to “000003”, the CPU 10 updates the display page to “000002” in S611. On the other hand, if the user slides the screen to the left opposite to the arrow 311 and it is judged by the CPU 10 in S610 that the display page is the preview image 314 of the page following “000003”, the CPU 10 updates the display page to “000004” in S611.

FIG. 8 is a diagram illustrating an example of the slide operation by the flick operation performed in regard to the job list.

More specifically, a job list screen 800 includes a job list display portion 801, list scroll buttons 802, a screen close button 803, a list display update button 804 and a title line 809. Incidentally, it is assumed that the predetermined gesture operation in the example of FIG. 8 is a gesture operation in up and down directions.

FIG. 8 shows the example of the operation in which the user performs a tap at a position 805, performs a drag downward as indicated by an arrow 807, and then releases the finger at a position 806 while maintaining the drag speed, thereby performing the downward flick operation. In this operation, the upper list is slid downward and displayed. On the other hand, if the user performs the flick operation in the opposite direction (i.e., the upward flick operation), the lower list is slid upward and displayed.

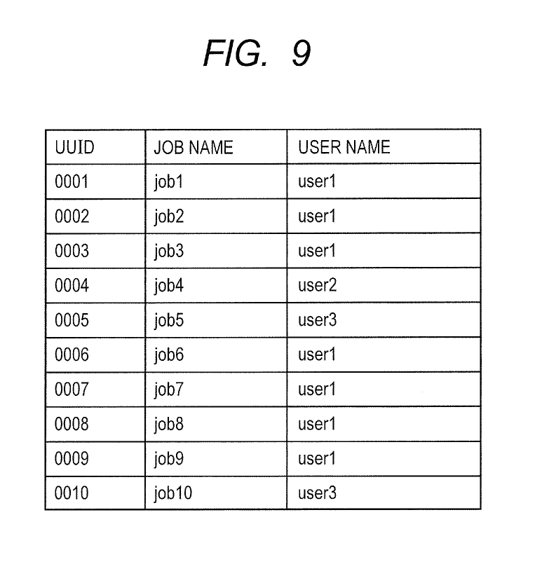

The display page of the list is represented by the headmost list displayed on the list screen. That is, if it is assumed that the job list data 406 displayed in the job list display portion 801 of FIG. 8 is the data illustrated in FIG. 9, the data currently displayed at the head is the data of “job3: user1”, whereby the display page is “0003”.

Then, if the data of “job3: user1” is slid downward by the downward flick operation of the user and thus the upper line of the relevant data must be displayed, it is judged by the CPU 10 in S610 that the display page exceeds the currently displayed page. In this case, the CPU 10 updates the display page to the previous page of “0002” on the basis of the data illustrated in FIG. 9. On the other hand, if the data is slid upward by the flick operation of the user in the opposite direction (i.e., the upward flick operation) and thus the data of “job3: user1” cannot be displayed, then it is judged by the CPU 10 in S610 that the display page exceeds the currently displayed page. In this case, the CPU 10 updates the display page to the next page of “0004” on the basis of the data illustrated in FIG. 9.

Incidentally, the action for the flick operation does not change on both the list display in the preview display illustrated in FIG. 3A and the list display of the character strings illustrated in FIG. 8. Namely, in both cases, the action follows a speed change as illustrated in FIG. 5 that an initial speed at the point that the user releases the finger from the screen is gradually decreased and then finally stopped.

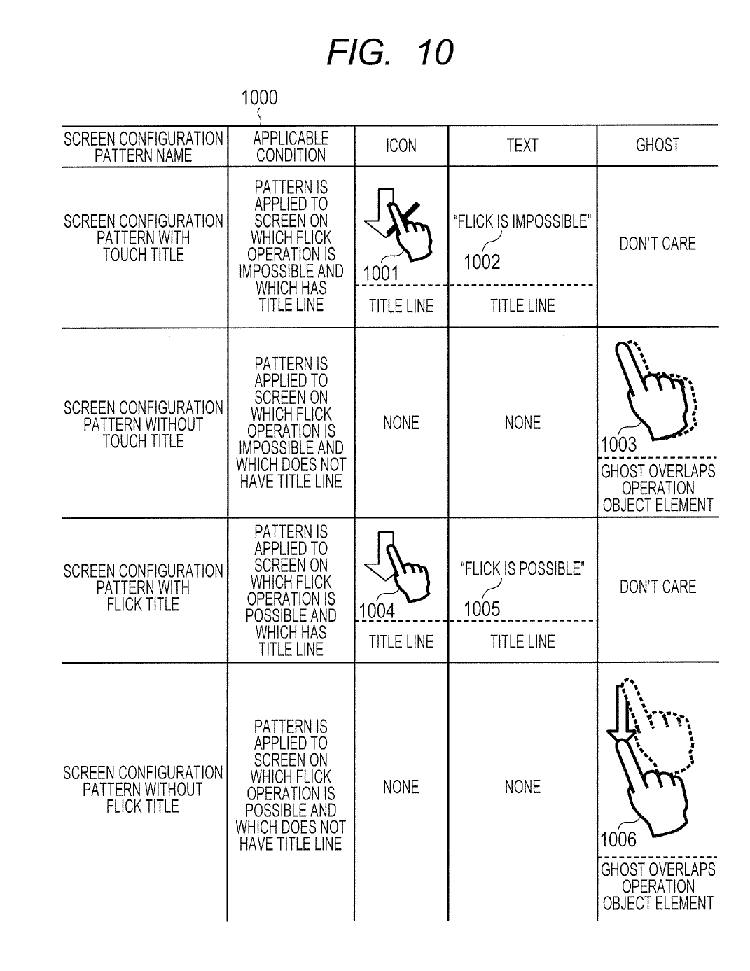

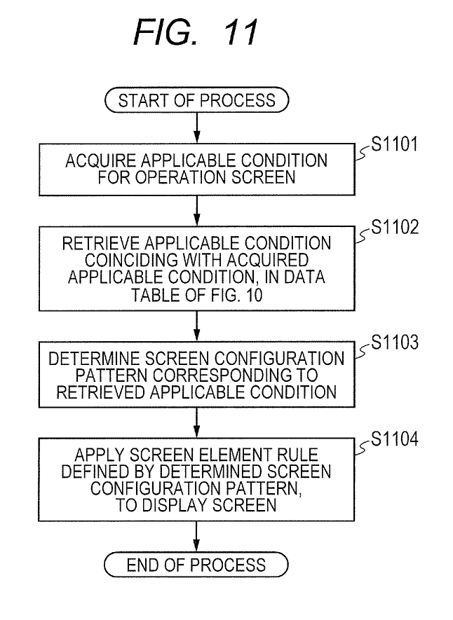

FIG. 10 is a diagram illustrating an example of a screen configuration pattern according to the present embodiment. Incidentally, the operation screen in the present embodiment is an example of the operation screen to which a plurality of screen configuration patterns are applicable.

Here, it should be noted that the screen configuration pattern is a set of “an applicable condition” by which the screen configuration pattern is applied and “a screen element rule” which is a rule of each element constituting the screen. Incidentally, the applicable condition is equivalent to screen information which includes information indicating whether or not the flick operation is possible on the operation screen, and information indicating whether or not the operation screen has a title line (display section) for displaying an icon and/or a message. Moreover, the screen element rule is a display rule for screen elements (icon, text, ghost, etc.) including two points of “what” is “displayed on where”. In the present embodiment, it is assumed that the RAM 13 stores a data table 1000 as illustrated in FIG. 10 on which the screen configuration patterns, the applicable conditions and the screen element rules have been associated with others. However, the storage medium for storing the data table is not limited to the RAM 13, and another storage medium may store the data table.

The CPU 10 stores the applicable condition for the currently displayed screen on the display unit 21 (a display or the like) in the RAM 13. When the applicable condition for the currently displayed screen is acquired from the RAM 13, the CPU 10 retrieves the applicable condition which coincides with the acquired applicable condition from the data table 1000 illustrated in FIG. 10. Then, the CPU 10 determines the screen configuration pattern corresponding to the retrieved applicable condition on the basis of the data table, and applies the screen element rule defined by the screen configuration pattern to the display screen.

FIG. 11 is a flow chart indicating an example of a process related to a display of the operation screen according to the present embodiment

In S1101, the CPU 10 acquires, from the RAM 13, the applicable condition for the screen currently displayed on the display unit 21, and advances the process to S1102.

In S1102, the CPU 10 retrieves, from the data table illustrated in FIG. 10, the applicable condition which coincides with the applicable condition acquired in S1101, and advances the process to S1103.

In S1103, the CPU 10 determines the screen configuration pattern corresponding to the applicable condition retrieved in S1102, and advances the process to S1104.

In S1104, the CPU 10 applies the screen element rule defined by the screen configuration pattern determined in S1103 to the display screen, and completes the process.

Hereinafter, the screen configuration pattern will be described in detail.

It should be noted that the example illustrated in FIG. 10 includes following four kinds of screen configuration patterns defined respectively.

More specifically, “SCREEN CONFIGURATION PATTERN WITH TOUCH TITLE” is a pattern to be applied to the screen on which the flick operation is impossible and which has the title line. Here, the screen element rule in this pattern is:

the CPU 10 displays an icon 1001 on the title line;
the CPU 10 displays a text 1002 of “FLICK IS IMPOSSIBLE” on the title line; and
the CPU 10 does not provide use of a ghost (hereinafter, described as “DON′T CARE” in FIG. 10).

Here, it should be noted that the ghost is a screen element which is temporarily displayed on the actual screen and thereafter made undisplayed by the CPU 10. In any case, the ghost will be later described in detail.

Moreover, “SCREEN CONFIGURATION PATTERN WITHOUT TOUCH TITLE” is a pattern to be applied to the screen on which the flick operation is impossible and which does not have a title line. Here, the screen element rule in this pattern is:

the CPU 10 does not display an icon;
the CPU 10 does not display a text; and
the CPU 10 displays a ghost 1003 such that the ghost overlaps an operation object element.

Moreover, “SCREEN CONFIGURATION PATTERN WITH FLICK TITLE” is a pattern to be applied to the screen on which the flick operation is possible and which has the title line. Here, the screen element rule in this pattern is:

the CPU 10 displays an icon 1004 on the title line;
the CPU 10 displays a text 1005 of “FLICK IS POSSIBLE” on the title line; and
the CPU 10 does not provide use of a ghost.

Moreover, “SCREEN CONFIGURATION PATTERN WITHOUT FLICK TITLE” is a pattern to be applied to the screen on which the flick operation is possible and which does not have a title line. Here, the screen element rule in this pattern is:

the CPU 10 does not display an icon;
the CPU 10 does not display a text; and
the CPU 10 displays a ghost 1006 such that the ghost overlaps an operation object element.

As just described, a technique which indicates a possible operation itself by means of a message, a typical icon, a ghost or the like is called explicit affordance.

In FIG. 10, only the screen elements which are necessary to decide the screen configuration pattern are illustrated. However, it is possible for the user to set other screen elements (a list display, etc.) through the operation unit 20 or the like as occasion arises.

Hereinafter, a case where the screen configuration pattern illustrated in FIG. 10 is applied to the job list screen 800 illustrated in FIG. 8 will be described.

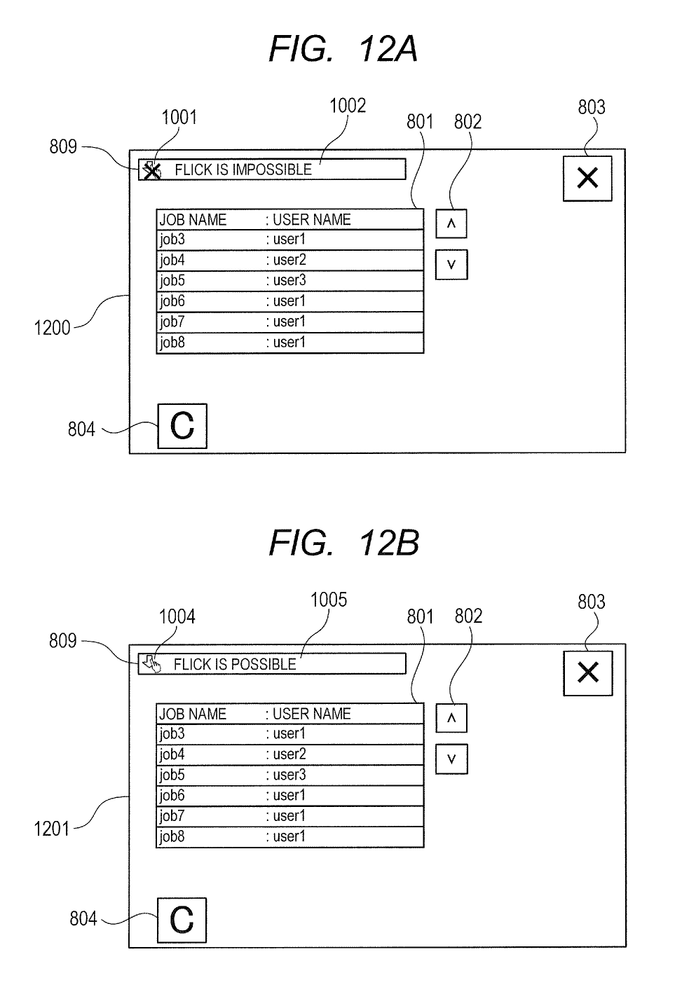

Initially, in a case where the user cannot perform the flick operation, since the title line 809 is provided on the job list screen 800, the screen configuration pattern to be applied to the job list screen 800 by the CPU 10 is “SCREEN CONFIGURATION PATTERN WITH TOUCH TITLE”. Therefore, the CPU 10 displays the icon 1001 and the text 1002 in the title line 809, whereby a job list screen 1200 illustrated in FIG. 12A is acquired.

On the other hand, in a case where the user can perform the flick operation, the screen configuration pattern to be applied to the job list screen 800 by the CPU 10 is “SCREEN CONFIGURATION PATTERN WITH FLICK TITLE”. Therefore, the CPU 10 displays the icon 1004 and the text 1005 in the title line 809, whereby a job list screen 1201 illustrated in FIG. 12B is acquired.

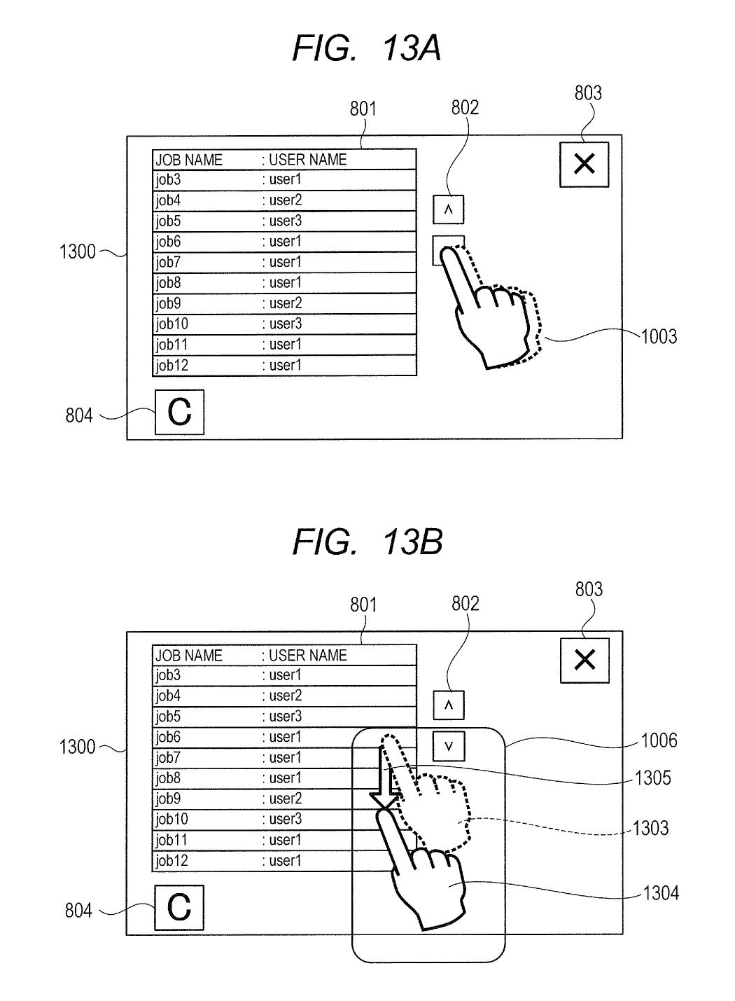

Subsequently, if the specification related to the number of lines to be displayed in the job list display portion 801 of FIG. 8 is changed from six lines to ten lines, it is impossible to display the title line 809. In such a case, in the case where the user cannot perform the flick operation, the screen configuration pattern to be applied to the job list screen 800 by the CPU 10 is “SCREEN CONFIGURATION PATTERN WITHOUT TOUCH TITLE”. In “SCREEN CONFIGURATION PATTERN WITHOUT TOUCH TITLE”, the CPU 10 displays the ghost 1003 such that the ghost overlaps the touch operation object element. Here, the touch operation object element on the job list screen 800 is the list scroll buttons 802. Consequently, when “SCREEN CONFIGURATION PATTERN WITHOUT TOUCH TITLE” is applied to the job list screen 800 by the CPU 10, a job list screen 1300 illustrated in FIG. 13A is acquired. On the job list screen 1300, the ghost 1003 moves so as to touch the list scroll button 802, and then vanishes.

On the other hand, in the case where the user can perform the flick operation, the screen configuration pattern to be applied to the job list screen 800 by the CPU 10 is “SCREEN CONFIGURATION PATTERN WITHOUT FLICK TITLE”. Here, the flick operation object element on the job list screen 800 is the job list display portion 801. Consequently, when “SCREEN CONFIGURATION PATTERN WITHOUT FLICK TITLE” is applied to the job list screen 800 by the CPU 10, a job list screen 1301 illustrated in FIG. 13B is acquired.

On the job list screen 1301, the ghost 1006 moves so as to flick the job list display portion 801, and then vanishes. More specifically, in the ghost 1006, the image of the finger is moved from a position 1303 to a position 1304, the job list display portion 801 is thus scrolled, and at the same time the effect of the flick operation is indicated by an arrow 1305.

Incidentally, the CPU 10 can display the ghost at the time of displaying the screen, or at periodic intervals. Moreover, the CPU 10 can display the ghost as a mere image, or by an animation. Moreover, the CPU 10 can display the ghost with appropriate transmittance. In any case, the user can define such display timing, as the screen element rule to the screen configuration pattern. In such a case, the CPU 10 controls the display of the ghost on the basis of the display timing set by the user. Incidentally, in the present embodiment, the ghost is provided to express the operation. However, for example, if the user wishes to express by a ghost that the operation object does not move, the CPU 10 may display an image of a key as the ghost.

As described above, the CPU 10 can control the display of the respective items of the screen configuration pattern by appropriately selecting or combining them as occasion arises.

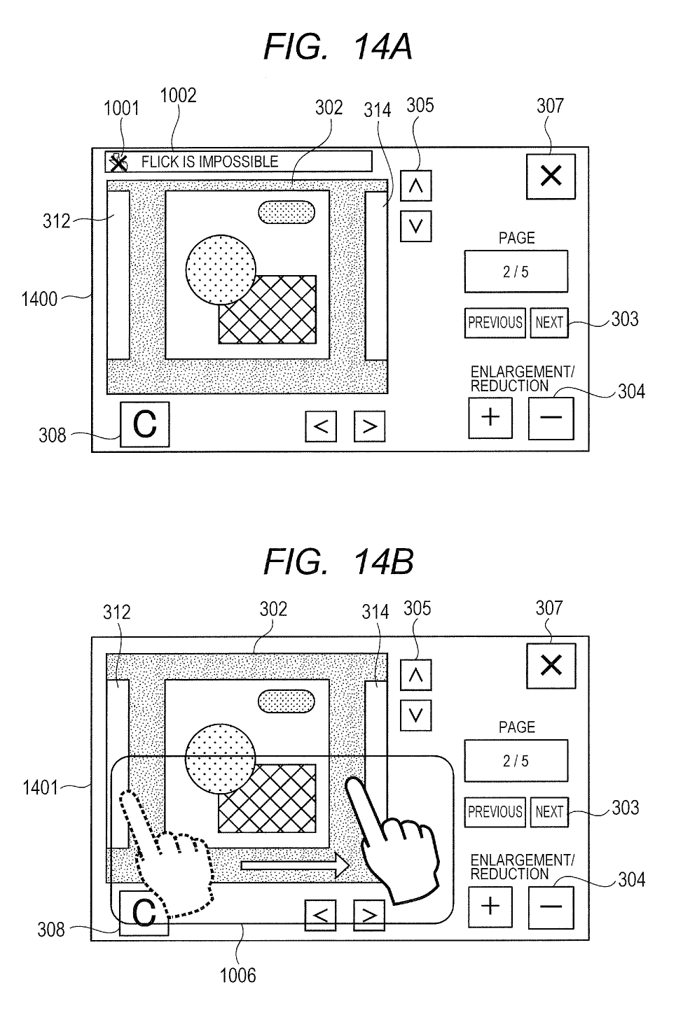

Each of FIGS. 14A and 14B is a diagram illustrating an example of the preview screen which is acquired when the screen configuration pattern illustrated in FIG. 10 is applied to the preview screen 301 illustrated in FIG. 3A. More specifically, the example that the user cannot perform the gesture operation and “SCREEN CONFIGURATION PATTERN WITH TOUCH TITLE” is applied to the previse screen 301 is shown by a preview screen 1400 illustrated in FIG. 14A. On the other hand, the example that the user can perform the gesture operation and “SCREEN CONFIGURATION PATTERN WITHOUT FLICK TITLE” is applied to the previse screen 301 is shown by a preview screen 1401 illustrated in FIG. 14B.

As just described, since the CPU 10 controls the display of the operation screen on the basis of the rule related to the screen configuration pattern, the user can consistently acknowledge the operability related to the whole apparatus. In addition, since the user can easily acknowledge, by the explicit affordance as described above, whether or not to be able to perform the gesture operation on the screen on which the user intends to perform the operation, he/she can study how to operate the screen without a waste.

### Second Embodiment

In the second embodiment of the present invention, it should be noted that the hardware constitution and the software configuration in the MFP 100 are the same as those in the first embodiment, and only a screen configuration pattern is different from that in the first embodiment.

Hereinafter, descriptions of the portions which are common to those in the first embodiment will be omitted in the present embodiment, and only portions which are different from the first embodiment will be described.

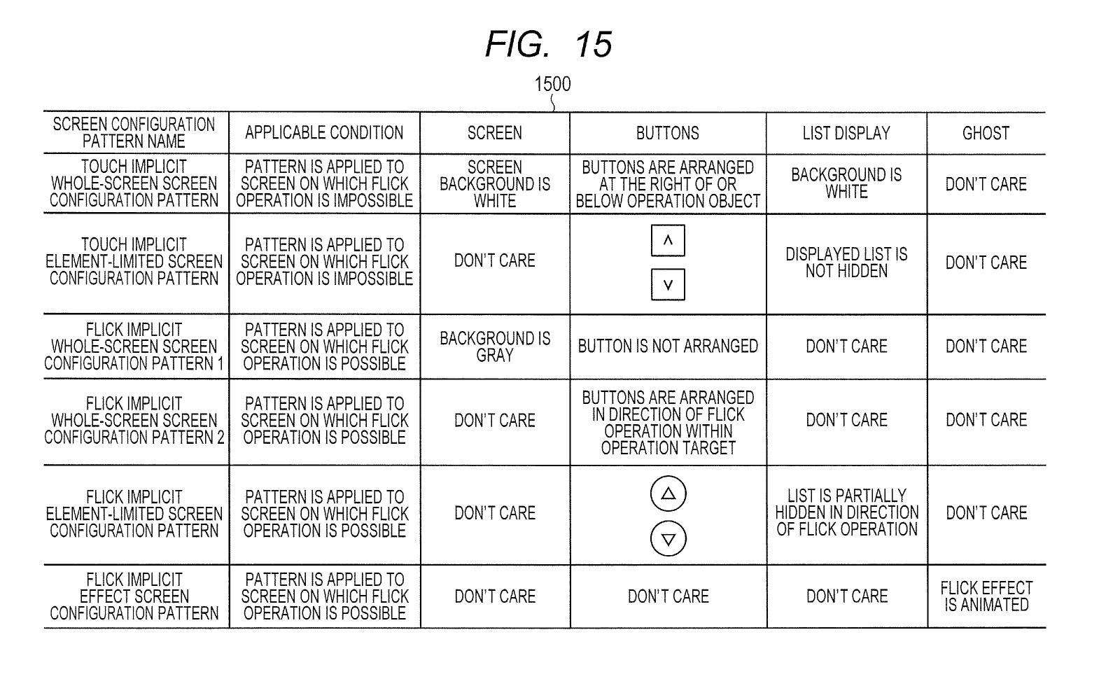

FIG. 15 is a diagram illustrating an example of a screen configuration pattern 1500 according to the present embodiment.

The present embodiment aims to cause a user to acknowledge whether or not to be able to perform a flick operation only by screen elements, without using explicit affordance. In any case, a technique in the present embodiment is called implicit affordance.

It should be noted that the example illustrated in FIG. 15 includes six kinds of screen configuration patterns defined respectively. Incidentally, the screen element rule in the implicit-affordance screen configuration pattern is defined abstractly as compared with the screen element rule in the explicit-affordance screen configuration pattern. More specifically, the screen element rule in the implicit-affordance screen configuration pattern includes a rule related to a background color of the screen, a rule related to a display form of the operation button, a rule related to a display form of the display list, and a rule related to an animation motion.

Hereinafter, the respective screen configuration patterns illustrated in FIG. 15 will be described, and also an example that each of the screen configuration patterns is applied to the job list screen 800 illustrated in FIG. 8 or the preview screen 301 illustrated in FIG. 3A will be described.

In “TOUCH IMPLICIT WHOLE-SCREEN SCREEN CONFIGURATION PATTERN”, the screen element rule to be applied to the whole, the wide range or the central part of the screen on which the flick operation is impossible has been defined. More specifically, in this screen element rule, the background colors of the screen and the list display have been defined as white, and the buttons have been defined to be arranged at the right of or below an operation object to be operated by the relevant buttons. Incidentally, use of a ghost is not defined in this screen element rule (hereinafter, described as “DON′T CARE” in FIG. 15). Incidentally, the application example of “TOUCH IMPLICIT WHOLE-SCREEN SCREEN CONFIGURATION PATTERN” is the job list screen 800.

In “TOUCH IMPLICIT ELEMENT-LIMITED SCREEN CONFIGURATION PATTERN”, the screen element rule which is limited to the screen elements related to the operation of the screen on which the flick operation is impossible has been defined. More specifically, in the relevant screen element rule, the external shape of each button has been defined as a square, and the list in the list display has been defined not to be hidden. Incidentally, the application examples of “TOUCH IMPLICIT ELEMENT-LIMITED SCREEN CONFIGURATION PATTERN” are the job list screen 800 and the preview screen 321.

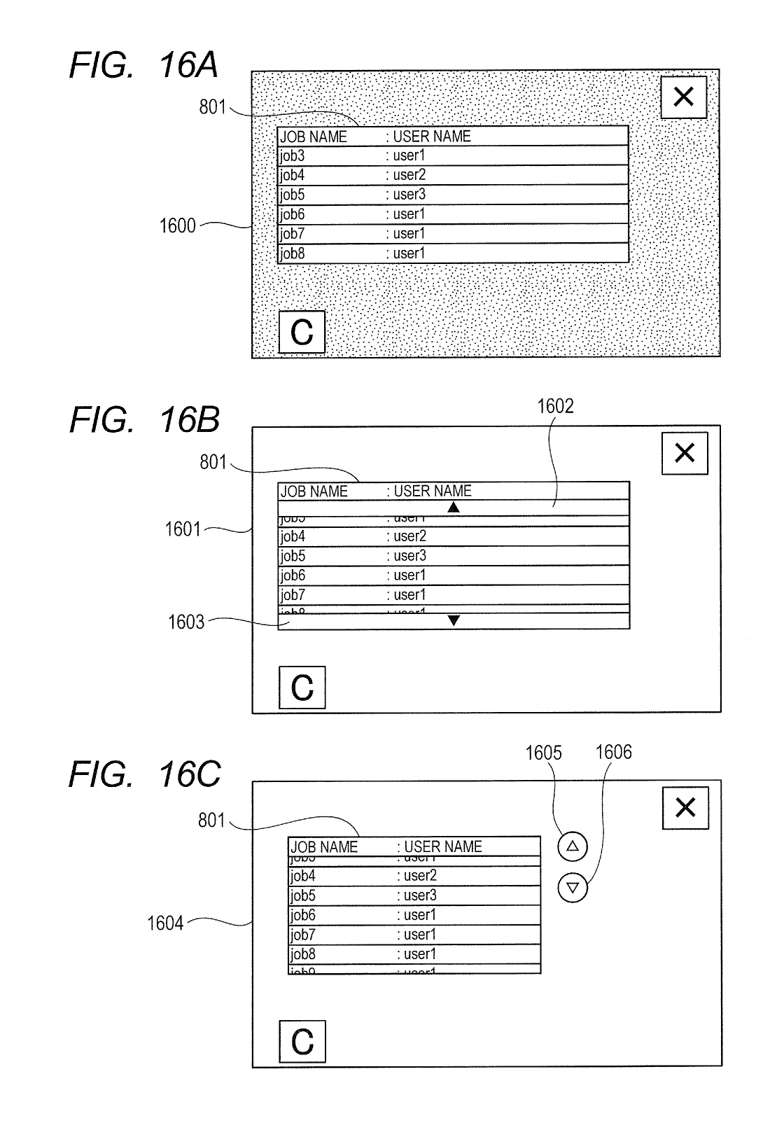

In “FLICK IMPLICIT WHOLE-SCREEN SCREEN CONFIGURATION PATTERN 1”, the screen element rule to be applied to the whole, the wide range or the central part of the screen on which the flick operation is possible has been defined. More specifically, in this screen element rule, the background color of the screen has been defined as gray, and a button has been defined not to be arranged. Incidentally, the application example of “FLICK IMPLICIT WHOLE-SCREEN SCREEN CONFIGURATION PATTERN 1” is a job list screen 1600 illustrated in FIG. 16A.

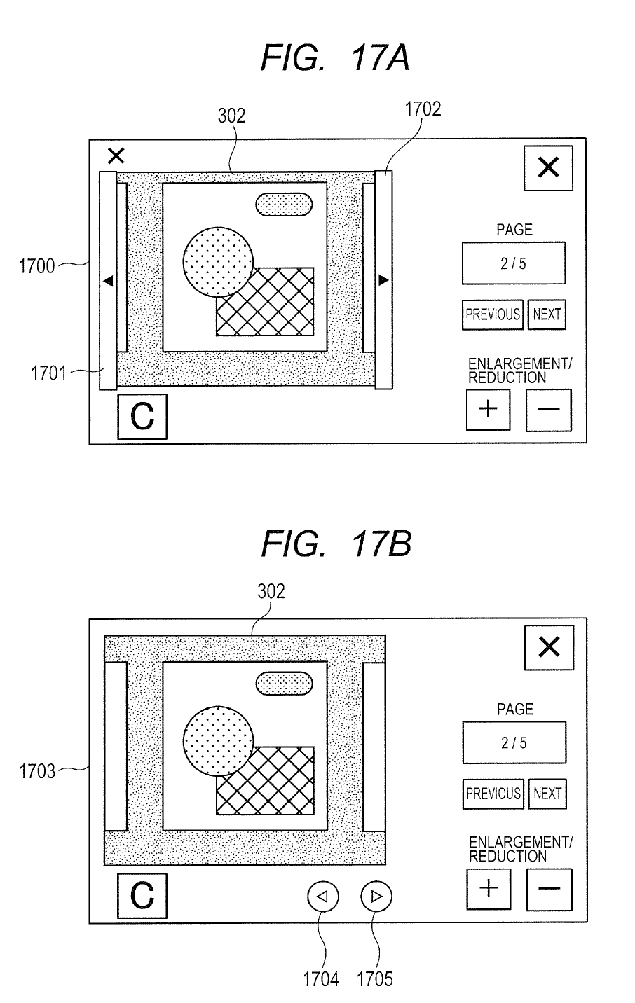

In “FLICK IMPLICIT WHOLE-SCREEN SCREEN CONFIGURATION PATTERN 2”, the screen element rule to be applied to the whole, the wide range or the central part of the screen on which the flick operation is possible has been defined. More specifically, in this screen element rule, the buttons have been defined to be arranged in the direction of the flick operation within an operation object to be operated by the relevant buttons. Incidentally, the application examples of “FLICK IMPLICIT WHOLE-SCREEN SCREEN CONFIGURATION PATTERN 2” are a job list screen 1601 illustrated in FIG. 16B and a preview screen 1700 illustrated in FIG. 17A. It should be noted that, in the respective drawings, the buttons for scrolling the list display items are arranged as a button 1602 and a button 1603 within the display area of the job list display portion 801 and as a button 1701 and a button 1702 within the preview display area 302. On the job list screen 1601, parts of the list lines which are the list display items are hidden by the button 1602 and the button 1603. Likewise, on the preview screen 1700, parts of the preview image which is the list content are hidden by the button 1701 and the button 1702.

In “FLICK IMPLICIT ELEMENT-LIMITED SCREEN CONFIGURATION PATTERN”, the screen element rule which is limited to the screen elements related to the operation of the screen on which the flick operation is possible has been defined. More specifically, in the relevant screen element rule, the external shape of each button has been defined as a circle, and a part of the list display has been defined to be hidden in the direction of the flick operation. Incidentally, the application examples of “FLICK IMPLICIT ELEMENT-LIMITED SCREEN CONFIGURATION PATTERN” are a job list screen 1604 illustrated in FIG. 16C and a preview screen 1703 illustrated in FIG. 17B. More specifically, each of a button 1605, a button 1606, a button 1704 and a button 1705 for scrolling the list display items has a circular external shape.

In “FLICK IMPLICIT EFFECT SCREEN CONFIGURATION PATTERN”, the screen element rule which is limited to the screen elements related to the operations of the screen on which the flick operation is possible has been defined. More specifically, in the relevant screen element rule, the list display items to be displayed in the job list display portion 801 or the preview display area 302 carries out an animation motion as if a flick operation is performed. That is, the CPU 10 applies the animation motion by a flick effect. Incidentally, the application example of “FLICK IMPLICIT EFFECT SCREEN CONFIGURATION PATTERN” is not specifically illustrated.

As just described, since the CPU 10 controls the display of the operation screen on the basis of the rule related to the screen configuration pattern, the user can imagine an operation other than the conventional touch operation and think of the gesture operation such as the flick operation or the like. In any case, the implicit affordance like this brings a certain advantage to the user, in which, if the user once accepts the above screen configuration rule, it is then possible to avoid that direct expressions make the screen cumbersome and complicated. In other words, the present embodiment has the effect of urging the user oneself to study how to operate and handle the screen.

### Third Embodiment

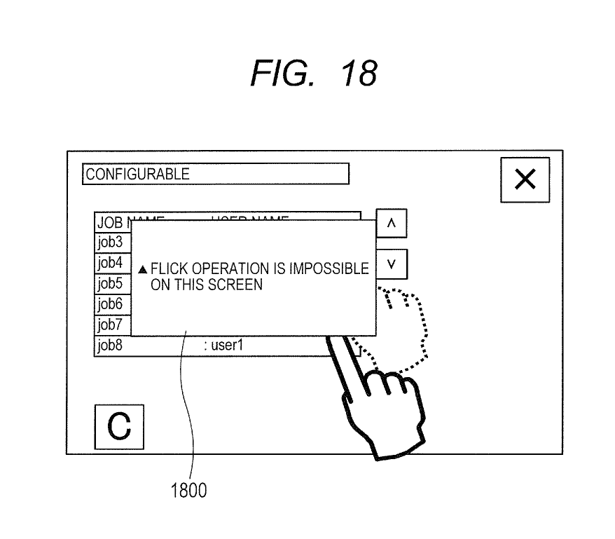

In the third embodiment of the present invention, when the CPU 10 detects a flick operation on the screen on which the flick operation is impossible, then the CPU displays on the screen a warning pop-up 1800 of “FLICK OPERATION IS IMPOSSIBLE ON THIS SCREEN” as illustrated in FIG. 18. This is an example of a process which is related to a false operation warning display by the CPU 10.

FIG. 18 is the diagram illustrating an example of the job list screen on which the warning pop-up 1800 is displayed. Incidentally, the CPU 10 automatically closes the warning pop-up 1800 after the elapse of a certain period of time.

Likewise, although it is not illustrated in the drawings, when the CPU 10 detects that any operation is not performed by the user for a certain period of time on a screen on which the flick operation is possible, then the CPU can display a warning pop-up for giving explicit affordance such as “FLICK OPERATION IS POSSIBLE ON THIS SCREEN”. This is an example of a process which is related to a non-detection warning display by the CPU 10.

### Other Embodiments

Incidentally, it is possible to achieve the embodiments of the present invention by the following process. That is, in this process, software (programs) for achieving the functions of the above embodiments is supplied to a system or an apparatus through a network or various storage media, and then a computer (e.g., a CPU, an MPU or the like) of the system or the apparatus reads and executes the supplied programs.

As just described, according to the processes explained in the above embodiments, a user can easily acknowledge whether or not to be able to perform the gesture operation on the screen on which the user intends to perform an operation.

Incidentally, the embodiments of the present invention can also be realized by a computer of a system or an apparatus that reads and executes computer executable instructions recorded on a storage medium (e.g., a non-transitory computer-readable storage medium) to perform the functions of one or more of the above embodiments of the present invention, and by a method performed by the computer of the system or the apparatus by, for example, reading and executing the computer executable instructions from the storage medium to perform the functions of one or more of the above embodiments. The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blue-ray Disc (BD)™), a flash memory device, a memory card, and the like.

While the present invention has been described with reference to the exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-215027, filed Sep. 27, 2012, which is hereby incorporated by reference herein in its entirety.

1. An image processing apparatus comprising:
an acquisition unit configured to acquire screen information related to whether or not an operation screen accepts an input by a gesture operation;
a retrieval unit configured to retrieve, from screen information associated with a plurality of screen configuration patterns applicable to the operation screen, the screen information which coincides with the screen information acquired by the acquisition unit;
a determining unit configured to determine the screen configuration pattern to be applied to the operation screen, based on the screen information retrieved by the retrieval unit; and
an applying unit configured to apply a display rule of a screen element defined by the screen configuration pattern determined by the determining unit to a display screen of the operation screen.

2. The image processing apparatus according to claim 1, wherein the screen information includes information related to whether or not the operation screen accepts the input by the gesture operation, and information related to whether or not a display section for displaying said information is included in the operation screen.

3. The image processing apparatus according to claim 2, wherein, in a case where the screen configuration pattern determined by the determining unit is the screen configuration pattern related to the screen information of the operation screen including the display section, the applying unit applies, to the display section, the display rule for displaying an icon and a message indicating whether or not the operation screen accepts the gesture operation.

4. The image processing apparatus according to claim 2, wherein, in a case where the screen configuration pattern determined by the determining unit is the screen configuration pattern related to the screen information of the operation screen not including the display section, the applying unit applies the display rule for displaying an operation related to an operation object by an animation.

5. The image processing apparatus according to claim 1 or 2, wherein, in accordance with whether or not the screen configuration pattern determined by the determining unit is the screen configuration pattern related to the screen information of the operation screen which accepts the input by the gesture operation, the applying unit applies the display rule related to at least any one of the screen elements of a background color of the screen, a display form of an operation button, a display form of a display list, and an animation motion.

6. The image processing apparatus according to any one of claims 1 to 5, further comprising a false operation warning display unit configured to display a warning of a false operation in a case where the input by the gesture operation by a user is detected on the operation screen to which the display screen which does not accept the input by the gesture operation is applied by the applying unit.

7. The image processing apparatus according to any one of claims 1 to 6, further comprising a non-detection warning display unit configured to display a warning of non-detection in a case where it is detected that there is no input operation by a user for a certain period of time on the operation screen related to the display screen to which the display rule has been applied by the applying unit.

8. An image processing method which is performed by an image processing apparatus, the method comprising:
an acquisition step of acquiring screen information related to whether or not an operation screen accepts an input by a gesture operation;
a retrieval step of retrieving, from screen information associated with a plurality of screen configuration patterns applicable to the operation screen, the screen information which coincides with the screen information acquired in the acquisition step;
a determining step of determining the screen configuration pattern to be applied to the operation screen, based on the screen information retrieved in the retrieval step; and
an applying step of applying a display rule of a screen element defined by the screen configuration pattern determined in the determining step to a display screen of the operation screen.

9. A non-transitory computer-readable program for causing a computer to perform an image processing method comprising:
an acquisition step of acquiring screen information related to whether or not an operation screen accepts an input by a gesture operation;
a retrieval step of retrieving, from screen information associated with a plurality of screen configuration patterns applicable to the operation screen, the screen information which coincides with the screen information acquired in the acquisition step;
a determining step of determining the screen configuration pattern to be applied to the operation screen, based on the screen information retrieved in the retrieval step; and
an applying step of applying a display rule of a screen element defined by the screen configuration pattern determined in the determining step to a display screen of the operation screen.
